(19) United States
(12) Patent Application Publication
(10) Pub. No.: US 2026/0330749 A1
(43) Pub. Date: Oct. 22, 2026

(54) CONTENT SERVER, CLIENT TERMINAL, IMAGE DISPLAY SYSTEM, DISPLAY DATA TRANSMISSION METHOD, AND DISPLAY IMAGE GENERATION METHOD

(71) Applicant: Sony Interactive Entertainment Inc., Tokyo (JP)

(72) Inventors: Xinyu Zhang, Tokyo (JP); Norihide Kaneko, Tokyo (JP); Kazuyuki Arimatsu, Tokyo (JP)

(73) Assignee: Sony Interactive Entertainment Inc., Tokyo (JP)

(21) Appl. No.: 19/691,501

(22) Filed: May 28, 2026

(30) Foreign Application Priority Data
Dec. 4, 2023 (WO) PCT/JP2023/043347

(51) Int. Cl. G06T 15/20; G06F 3/01; G06N 3/045; G06T 3/40; G06T 15/08

(52) U.S. Cl. CPC G06T 15/20; G06F 3/013; G06N 3/045; G06T 3/40; G06T 15/08

(57) ABSTRACT

A content server obtains neural networks representing a plurality of types of three-dimensional scene information by generating training images representing each scene of a display world and performing machine learning. The content server generates a plurality of neural networks, divides each of the plurality of neural networks into packets, randomizes an order of packets, and transmits the packets to a client terminal. The client terminal renders display images corresponding to a latest display viewpoint by restoring the original neural network from the neural networks.

### CROSS-REFERENCES TO RELATED APPLICATION

This application is a continuation of International Patent Application PCT/JP2023/043347, filed Dec. 4, 2023, entitled “CONTENT SERVER, CLIENT TERMINAL, IMAGE DISPLAY SYSTEM, DISPLAY DATA TRANSMISSION METHOD, AND DISPLAY IMAGE GENERATION METHOD”, which is hereby incorporated by reference in its entirety.

### BACKGROUND

The present disclosure relates to a content server, a client terminal, an image display system, a display data transmitting method, and a display image generating method for displaying an image of a three-dimensional display world.

It has become possible to enjoy various types of electronic content irrespective of a viewing/listening environment due to the expansion of communication networks and the development of an image processing technology in recent years. For example, in a field of electronic games, a system has spread in which a server collects operation information input to individual client terminals and distributes a game image in which the operation information is reflected as needed, thereby enabling a plurality of players to participate in the same game irrespective of locations of the players.

### SUMMARY

Without being limited to the electronic games, electronic content in a format in which a moving image generated in real time according to a user operation is distributed from the server can use an abundant processing environment of the server. Thus, the display of a high-quality image is facilitated while an effect of processing performance of a client terminal is minimized. On the other hand, because the transmission of the operation information from the client terminal and the processing of data transmission from the server that receives the operation information intervene at all times, the display may not be able to follow a viewpoint operation, or an image may be lost due to a packet loss. There is consequently a possibility of a decrease in quality of user experience.

The present invention has been made in view of such problems. It is an object of the present disclosure to provide a technology that, in the image processing of content involving distribution from a server, reduces an effect of the distribution on the quality of user experience.

In order to solve the above problems, a certain aspect of the present disclosure relates to a content server. This content server includes a training image generating section configured to generate, as training images, images representing states in which each scene of a three-dimensional display world whose conditions change according to a user operation is viewed from a plurality of viewpoints, a type-specific 3D scene information obtaining section configured to obtain a plurality of types of 3D scene information representing three-dimensional information of each scene by machine learning using the training images as labeled data, and a 3D scene information transmitting section configured to transmit data of the plurality of types of 3D scene information to a client terminal configured to render a display image by using the 3D scene information in order of completion of the machine learning of each scene.

Another aspect of the present disclosure relates to a client terminal. This client terminal includes an input information obtaining section configured to obtain information regarding a user operation and information regarding a display viewpoint with respect to a three-dimensional display world, a 3D scene information obtaining section configured to obtain, from a server, data of a plurality of types of 3D scene information representing three-dimensional information, the 3D scene information being obtained by machine learning, for each scene of the display world whose conditions change according to the user operation, and an image generating section configured to render at least a part of a frame of a display image by using the 3D scene information obtained immediately previously, on the basis of the display viewpoint that is latest.

Yet another aspect of present disclosure relates to an image display system. This image display system includes a client terminal configured to display an image of a three-dimensional display world whose conditions change according to a user operation and a content server configured to transmit data to be used for generation of a display image, the content server including a training image generating section configured to generate, as training images, images representing states in which each scene of the display world is viewed from a plurality of viewpoints, a type-specific 3D scene information obtaining section configured to obtain a plurality of types of 3D scene information representing three-dimensional information of each scene by machine learning using the training images as labeled data, and a 3D scene information transmitting section configured to transmit data of the plurality of types of 3D scene information to the client terminal in order of completion of the machine learning of each scene, and the client terminal including an input information obtaining section configured to obtain information regarding the user operation and information regarding a display viewpoint with respect to the display world, a 3D scene information obtaining section configured to obtain the data of the plurality of types of 3D scene information from the content server, and an image generating section configured to render at least a part of a frame of a display image by using the 3D scene information obtained immediately previously, on the basis of the display viewpoint that is latest.

Yet another aspect of present disclosure relates to a display data transmitting method. This display data transmitting method includes a step of generating, as training images, images representing states in which each scene of a three-dimensional display world whose conditions change according to a user operation is viewed from a plurality of viewpoints, a step of obtaining a plurality of types of 3D scene information representing three-dimensional information of each scene by machine learning using the training images as labeled data, and a step of transmitting data of the plurality of types of 3D scene information to a client terminal configured to render a display image by using the 3D scene information in order of completion of the machine learning of each scene.

Yet another aspect of present disclosure relates to a display image generating method. This display image generating method includes a step of obtaining information regarding a user operation and information regarding a display viewpoint with respect to a three-dimensional display world, a step of obtaining, from a server, data of a plurality of types of 3D scene information representing three-dimensional information, the 3D scene information being obtained by machine learning, for each scene of the display world whose conditions change according to the user operation, and a step of rendering at least a part of a frame of a display image by using the 3D scene information obtained immediately previously, on the basis of the display viewpoint that is latest.

It is to be noted that any combinations of the above constituent elements as well as modes obtained by converting expressions of the present disclosure between a method, a device, a system, a computer program, a data structure, a recording medium, and the like are also effective as modes of the present disclosure.

According to the present disclosure, in the image processing of content involving distribution from a server, an effect of the distribution on the quality of user experience can be reduced.

### BRIEF DESCRIPTION OF DRAWINGS

FIG. 1 is a diagram illustrating an example of a configuration of an image display system to which a present embodiment can be applied.

FIG. 2 is a diagram illustrating an internal circuit configuration of a client terminal according to the present embodiment.

FIG. 3 is a diagram illustrating a basic flow of image processing according to the present embodiment in comparison with a conventional technology.

FIG. 4 is a diagram illustrating a configuration of functional blocks of a client terminal and a content server in the present embodiment.

FIG. 5 is a diagram schematically illustrating a procedure for the content server to obtain 3D scene information in the present embodiment.

FIG. 6 is a diagram of assistance in explaining a mode of obtaining 3D scene information of a different range in the present embodiment.

FIG. 7 is a diagram schematically illustrating transitions of data in the transmission and reception of 3D scene information in the present embodiment.

FIG. 8 is a diagram of assistance in explaining a temporal relation between machine learning in the content server and image rendering in the client terminal in the present embodiment.

FIG. 9 is a diagram of assistance in explaining image correction processing by an image generating section of the client terminal in the present embodiment.

### DETAILED DESCRIPTION

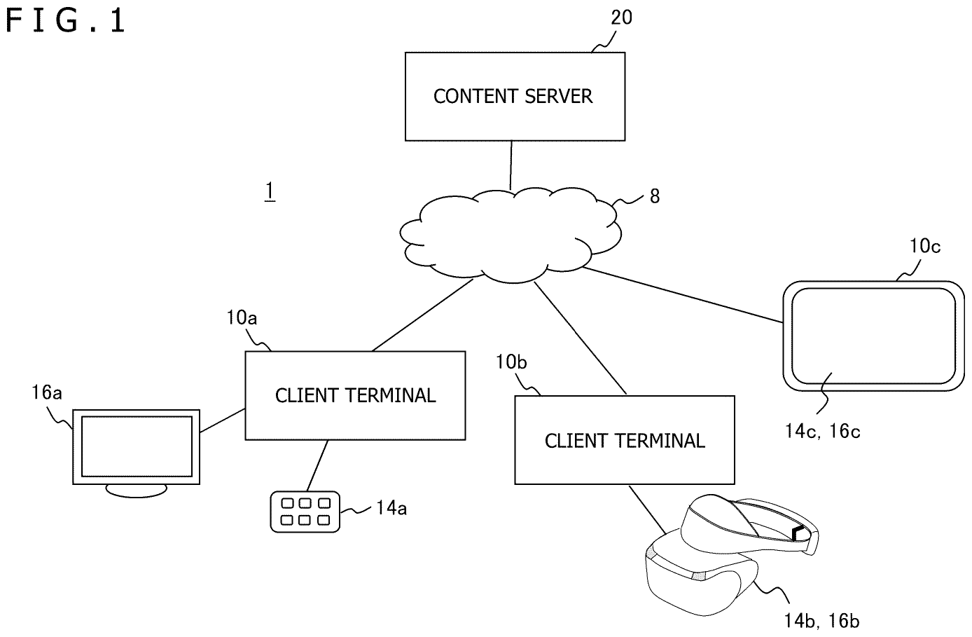

FIG. 1 illustrates an example of a configuration of an image display system to which a present embodiment can be applied. The image display system 1 includes client terminals 10a, 10b, and 10c that display an image according to a user operation, and a content server 20 that provides data to be used for the display. The client terminals 10a, 10b, and 10c are respectively connected with input devices 14a, 14b, and 14c for the user operation and display devices 16a, 16b, and 16c for displaying an image. The client terminals 10a, 10b, and 10c and the content server 20 can establish communication therebetween via a network 8 such as a world area network (WAN) or a local area network (LAN).

The client terminals 10a, 10b, and 10c, the display devices 16a, 16b, and 16c, and the input devices 14a, 14b, and 14c may each be connected either by wire or wirelessly. Alternatively, two or more of these devices may be formed integrally with each other. For example, the client terminal 10b in the figure is connected to a head-mounted display as the display device 16b. The head-mounted display can change a field of view of a display image according to movement of a user wearing the head-mounted display on a head portion thereof. The head-mounted display therefore functions also as the input device 14b.

In addition, the client terminal 10c is a portable terminal, and is formed integrally with the display device 16c and the input device 14c as a touch pad that covers the screen of the display device 16c. Thus, there are no limitations on the external shapes and connection modes of the devices illustrated in the figure. The numbers of the client terminals 10a, 10b, and 10c and the content server 20 connected to the network 8 are not limited to any specific numbers either. Hereinafter, the client terminals 10a, 10b, and 10c will be referred to collectively as a client terminal 10, the input devices 14a, 14b, and 14c will be referred to collectively as an input device 14, and the display devices 16a, 16b, and 16c will be referred to collectively as a display device 16.

The input device 14 may be one of ordinary input devices such as a controller, a keyboard, a mouse, a touch pad, and a joystick and various types of sensors such as a motion sensor and a camera provided to the head-mounted display, or a combination thereof. The input device 14 supplies the details of a user operation to the client terminal 10. The display device 16 may be an ordinary display such as a liquid crystal display, a plasma display, an organic electroluminescence (EL) display, a wearable display, or a projector. The display device 16 displays an image output from the client terminal 10.

The content server 20 supplies the client terminal 10 with the data of content involving image display. There is no particular limitation on the kind of the content, and the content may be either of an electronic game, an image for an ornamental purpose, a web page, a video chat using avatars, and the like. In the present embodiment, the content server 20 sequentially obtains information regarding a user operation on the input device 14 from the client terminal 10, causes the information to be reflected in a display target world, and then transmits necessary data such that an image representing the display target world is displayed on the client terminal 10 side.

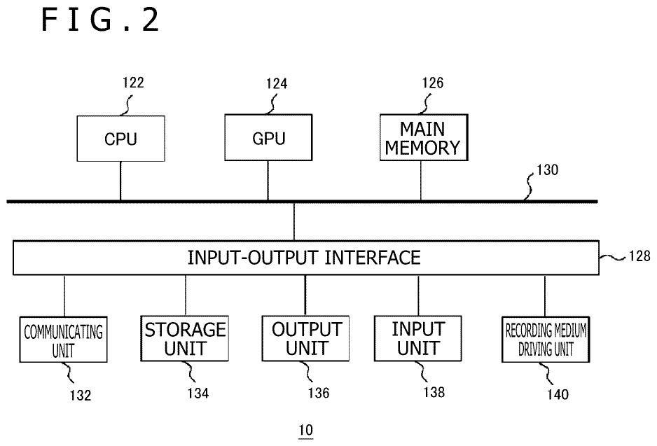

FIG. 2 illustrates an internal circuit configuration of the client terminal 10. The client terminal 10 includes a central processing unit (CPU) 122, a graphics processing unit (GPU) 124, and a main memory 126. These parts are interconnected via a bus 130. The bus 130 is further connected with an input-output interface 128. The input-output interface 128 is connected with a communicating unit 132 constituted by a peripheral device interface of a universal serial bus (USB) or the like and a network interface of a wired or wireless LAN, a storage unit 134 such as a hard disk drive and a nonvolatile memory, an output unit 136 for outputting data to the display device 16, an input unit 138 for inputting data from the input device 14, and a recording medium driving unit 140 for driving a removable recording medium such as a magnetic disk, an optical disk, or a semiconductor memory.

The CPU 122 controls the whole of the client terminal 10 by executing an operating system stored in the storage unit 134. The CPU 122 also executes various types of programs read from the removable recording medium and loaded into the main memory 126, or downloaded via the communicating unit 132. The GPU 124 performs rendering processing according to a rendering instruction from the CPU 122 and stores a display image in a frame buffer not illustrated. Then, the display image stored in the frame buffer is converted into a video signal, and the video signal is output to the output unit 136. The main memory 126 is constituted by a random access memory (RAM), and stores a program and data necessary for processing. The content server 20 may also have a similar internal circuit configuration.

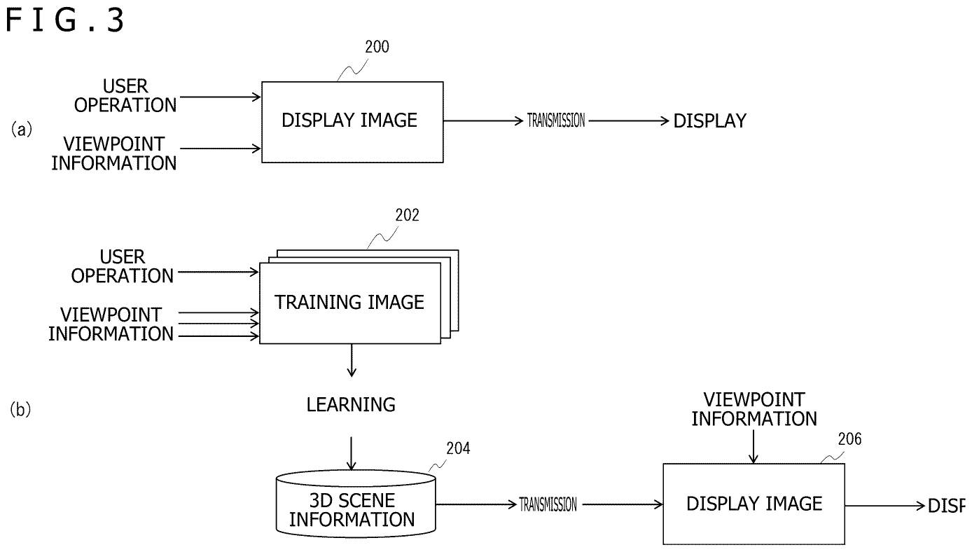

FIG. 3 illustrates a basic flow of image processing according to the present embodiment in comparison with a conventional technology. In the present embodiment, the world of a three-dimensional space in which various objects are present is set as a main display target. The conditions of the world change according to specifications of the program or the like and user operations. In a case of ordinary processing illustrated in (a), the content server obtains, as needed, information regarding the details of a user operation and the position of a viewpoint and a direction of a line of sight with respect to the display world. Hereinafter, the whole of the three-dimensional space as a display target will be referred to as the “display world,” and the state of the display world within the display field of view or in the vicinity thereof will be referred to as a “scene.” In addition, a position of the viewpoint and the direction of the line of sight with respect to the scene may be collectively referred to simply as the “viewpoint.” The viewpoint may be manually operated by the user via the input device 14, or may be derived from movement of the head portion of the user by the motion sensor included in the head-mounted display or the like.

The content server renders a display image 200 in the field of view corresponding to viewpoint information while changing the scene in such a manner that the scene corresponds to a user operation. The content server generates the display image 200 by, for example, well-known computer graphics rendering techniques such as ray tracing and rasterization. The content server transmits the generated display image 200 to the client terminal. The client terminal displays the display image 200 on the display device. When the processing illustrated in the figure is repeated at a predetermined frame rate, the client terminal side displays a moving image representing a change in the scene according to a user operation or the like.

Also in the present embodiment illustrated in (b), the content server 20 obtains, as needed, information regarding the details of a user operation and the position of the viewpoint and the direction of the line of sight with respect to the display world, and similarly renders an image while changing the scene in such a manner that the scene corresponds to the information. On the other hand, in the present embodiment, the content server 20 sets the image as a training image 202, and uses the training image 202 as labeled data for machine learning. The content server 20 collects training images 202 and performs machine learning, and thereby generates 3D scene information 204 representing three-dimensional information of the scene.

There is neural radiance fields (NeRF) as a method for gaining information of a three-dimensional space by machine learning (see, for example, Ben Mildenhall and five others, “NeRF: Representing Scenes as Neural Radiance Fields for View Synthesis,” Communications of the ACM, January 2022, Vol. 65, No. 1, pp. 99-106). In a case of introducing NeRF in the present embodiment, first, each piece of viewpoint information, that is, the positions of virtual viewpoints and the directions of lines of sight, which are determined at a time of the generation of the training images 202, are set as input, the corresponding training images 202 are set as labeled data, and data representing the three-dimensional information of the scene is obtained by regression using a multilayer perceptron (MLP).

This data is a neural network that receives, as input, a five-dimensional parameter including position coordinates (x, y, z) and a direction vector d (θ, φ) in the three-dimensional space, and outputs a volume density σ and color information c (RGB) of three primary colors. In the present embodiment, the data of the neural network is referred to as “3D scene information.” Incidentally, various improving methods have been proposed for NeRF, and in the present embodiment, a concrete method thereof is not limited to a specific one either. In addition, the method of the machine learning is not intended to be limited to NeRF.

Details represented by the training images 202 and, in turn, the 3D scene information 204 in the present embodiment can change from moment to moment. The figure illustrates conditions in which the 3D scene information 204 of the scene at one certain time or in a minute time that can be regarded as one time is generated. Hereinafter, the scene at one time or in a minute time that can be regarded as one time may be expressed as “one scene.” Incidentally, when there is no movement in the display world, the scene can be handled as “one scene” irrespective of time. In addition, when 3D scene information 204 is obtained for a previous scene, the content server 20 updates the 3D scene information 204 in such a manner that the 3D scene information 204 corresponds to a next scene. Hereinafter, the generation and updating of the 3D scene information may be referred to collectively as the “obtainment” of the 3D scene information.

In order to obtain the 3D scene information 204 of high accuracy, the content server 20 desirably collects the training images 202 of one scene from as many viewpoints as possible. The content server 20 may therefore collect the training images 202 by the following methods, for example.
(1) The content server 20 itself generates viewpoints suitable for the learning on the periphery of the viewpoint defining the field of view of an image to be actually displayed, and generates corresponding images.
(2) The content server 20 uses images displayed on the terminals of a plurality of users viewing the same scene.

Hereinafter, the viewpoint defining the actual display field of view in the client terminal 10 will be referred to as a “display viewpoint,” and will be distinguished from “training viewpoints” set at a time of generating the training images. The content server 20 may perform only one of (1) and (2), or may perform both. For example, viewpoints insufficient in (2) may be supplemented by (1). The content server 20 transmits the 3D scene information 204 as a learning result to the client terminal 10. The client terminal 10 generates a display image 206 by using the transmitted 3D scene information 204.

By using the 3D scene information 204, the client terminal 10 can represent a state of viewing the scene from any viewpoint with high quality under a relatively low load. In a case where NeRF is applied, the client terminal 10 obtains a pixel value C(r) of the display image as follows by volume rendering that generates a light ray r passing through each pixel of a view screen from the display viewpoint, and integrates colors along a direction of the light ray.

$$C ( r ) = {\int }_{{t}_{n}}^{{t}_{f}} T ( t ) σ ( r ( t ) ) c ( r ( t ) , d ) dt \qquad Math . 1$$

Here, tₙ and t_{f} are respectively a proximal end and a distal end of the ray r, and T(t) is a cumulative transmittance in the direction of the ray, and is expressed as follows.

$$T ( t ) = exp ( - {\int }_{{t}_{n}}^{t} σ ( r ( s ) ) d s ) \qquad Math . 2$$

By repeating the processing illustrated in the figure for movement in the scene, the content server 20 updates the 3D scene information 204 at a predetermined rate and sequentially transmits the 3D scene information 204 to the client terminal 10. The client terminal 10 generates the display image 206 while updating the 3D scene information being used. The client terminal 10 can thereby represent, from any viewpoint, a moving image having changes similar to those of the training images 202 generated by the content server 20. For example, the client terminal 10 renders the display image 206 representing a state of viewing the scene from the viewpoint immediately before display by using the latest 3D scene information 204. The client terminal 10 can thereby display the image with a small delay in response to a change in the viewpoint.

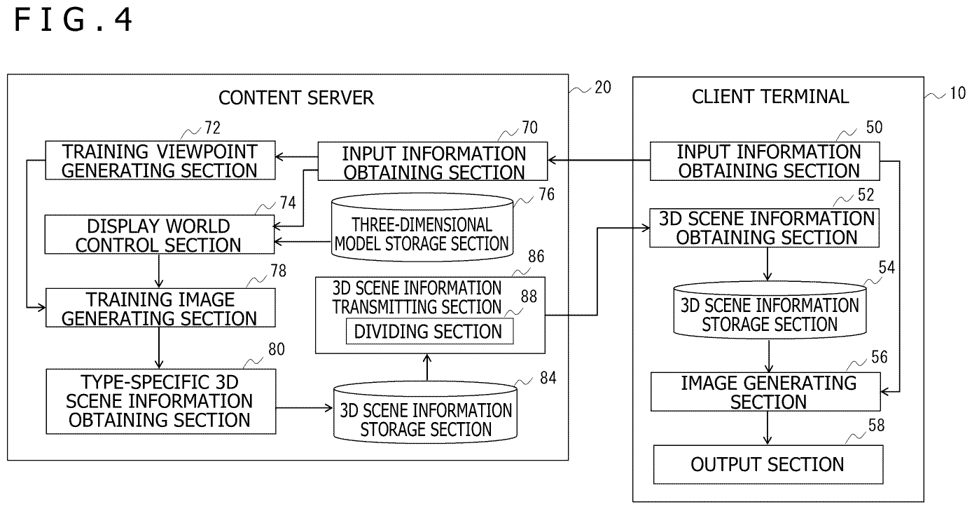

FIG. 4 illustrates a configuration of functional blocks of the client terminal 10 and the content server 20 in the present embodiment. The functions of constituent elements in functional blocks illustrated in the figure may be implemented in a circuit (circuitry) or a processing circuit (processing circuitry) including a general-purpose processor, an application-specific processor, an integrated circuit, application specific integrated circuits (ASICs), a CPU, a conventional type circuit, and/or a combination thereof configured to or programmed to implement functions described in the present specification. A processor is regarded as a circuit (circuitry) or a processing circuit (processing circuitry) including transistors and other circuits. The processor may be a processor (programmed processor) programmed to execute a program stored in the memory.

In the present specification, a circuit (circuitry), a unit, and means are hardware programmed to implement described functions or hardware that performs the described functions. The hardware may be any hardware disclosed in the present specification or any hardware programmed to implement the described functions or known to perform the described functions. In a case where the hardware is a processor regarded as a circuit (circuitry) type, the circuit (circuitry), the means, or the unit is a combination of hardware and software used to configure the hardware and/or the processor.

The client terminal 10 includes an input information obtaining section 50 that obtains input information such as a user operation, a 3D scene information obtaining section 52 that obtains the data of the 3D scene information from the content server 20, a 3D scene information storage section 54 that stores the obtained data of the 3D scene information, an image generating section 56 that generates a display image, and an output section 58 that outputs the data of the display image. The input information obtaining section 50 obtains the details of a user operation from the input device 14 as needed. The user operation includes a selection and a start of content, a command input for the content being executed, and the like.

The input information obtaining section 50 also obtains information regarding the display viewpoint with respect to the display world from the input device 14 or the head-mounted display as needed or at predetermined time intervals. A technology is well-known which detects the position and posture of the head portion of the user wearing the head-mounted display and obtains the information regarding the viewpoint on the basis of the position and posture of the head portion of the user. The technology may be applied also in the present embodiment. The input information obtaining section 50 supplies the obtained information to the content server 20 and the image generating section 56 as appropriate. The 3D scene information obtaining section 52 sequentially obtains, from the content server 20, the data of the 3D scene information that is continually updated.

As will be described later, the 3D scene information obtaining section 52 obtains a plurality of types of 3D scene information representing one scene from the content server 20. The 3D scene information storage section 54 stores the data of the plurality of types of 3D scene information obtained by the 3D scene information obtaining section 52. When the 3D scene information obtaining section 52 obtains new 3D scene information, the 3D scene information obtaining section 52 updates the data of the same type of 3D scene information stored in the 3D scene information storage section 54.

The image generating section 56 renders a display image at a predetermined frame rate by using the data of 3D scene information immediately previously stored in the 3D scene information storage section 54. Here, the image generating section 56 obtains the latest display viewpoint from the input information obtaining section 50, and renders the image with a corresponding field of view by a method such as volume rendering described above. When the 3D scene information corresponding to a change in the scene can be prepared by using the machine learning, the client terminal 10 can render a high-quality image under a light load as compared with processing such as normal ray tracing even when the client terminal 10 generates the display image.

By performing rendering using the plurality of types of 3D scene information, the image generating section 56 changes the display image representing one scene temporally, spatially, or both. For example, in a mode in which the content server 20 transmits the data of the 3D scene information in order of increasing information density, the image generating section 56 updates the display image by sequentially using the transmitted 3D scene information. It is thereby possible to display an image representing one scene with a low delay and maintain visual image quality because resolution increases gradually. The output section 58 outputs the image rendered by the image correcting section 92 to the display device 16 at a predetermined rate to make the image displayed by the display device 16.

The content server 20 includes an input information obtaining section 70 that obtains the input information from the client terminal 10, a training viewpoint generating section 72 that generates training viewpoints, a display world control section 74 that controls the display world, a three-dimensional model storage section 76 that stores three-dimensional models of objects, a training image generating section 78 that generates training images, a type-specific 3D scene information obtaining section 80 that obtains the data of a plurality of types of 3D scene information, a 3D scene information storage section 84 that stores the obtained data of the 3D scene information, and a 3D scene information transmitting section 86 that transmits the data of the 3D scene information to the client terminal 10.

The input information obtaining section 70 obtains information regarding the details of a user operation and the viewpoint from the client terminal 10 as needed or at predetermined time intervals. The training viewpoint generating section 72 generates a plurality of training viewpoints for generating training images. The training viewpoint generating section 72 generates, by a predetermined rule, the training viewpoints on the periphery of the latest display viewpoint obtained by the input information obtaining section 70. The training viewpoint generating section 72, for example, arranges a predetermined number of training viewpoints uniformly within a sphere having a predetermined radius with the latest display viewpoint as a center of the sphere. Here, the predetermined radius is set to be, for example, a value obtained by multiplying a highest speed assumed in the movement of the viewpoint by a longest time until display using the corresponding data is made.

The training viewpoint generating section 72 is not limited to arranging the training viewpoints uniformly, and may arrange more training viewpoints in a range in which the viewpoint is expected to move according to the conditions of the display world and the like. In addition, the training viewpoint generating section 72 may uniformly set lines of sight in a predetermined number of directions for the viewpoint at each position, or may set more lines of sight in a direction in which the line of sight is expected to move. Incidentally, the training viewpoint generating section 72 may also set the display viewpoint itself as a latest training viewpoint.

The display world control section 74 controls the three-dimensional display world represented as content according to the details of the user operation obtained by the input information obtaining section 70 and the like. In a case where the content is assumed to be an electronic game, for example, the display world control section 74 disposes a necessary object such as a user character in a virtual space as a stage of the electronic game, and imparts motion corresponding to a command input by the user or a specification of the program.

The three-dimensional model storage section 76 stores the three-dimensional models of objects present in the display world in advance. The display world control section 74 uses the three-dimensional models for the construction of the display world by reading the three-dimensional models as appropriate. The training image generating section 78 generates, as training images, images of a scene as viewed from the plurality of training viewpoints generated by the training viewpoint generating section 72. The training image generating section 78 preferably generates the training images by using a method capable of rendering high-quality images, such as ray tracing.

The type-specific 3D scene information obtaining section 80 uses the training images generated by the training image generating section 78, to generate 3D scene information by machine learning as described above and update the 3D scene information in such a manner that the 3D scene information corresponds to a change in the scene. Here, the type-specific 3D scene information obtaining section 80 obtains a plurality of types of 3D scene information representing one scene. For example, the type-specific 3D scene information obtaining section 80 obtains a plurality of pieces of 3D scene information different from each other in terms of spatial density of the represented information. Hereinafter, the spatial density of the information possessed by the 3D scene information will be referred to as “information density.” The information density may be reworded as the resolution of the information possessed by the 3D scene information or the spatial frequency of the information.

According to the document on NeRF described above, for example, a high-frequency component of an output vector is enabled to be represented more accurately by performing Positional Encoding, which converts a vector input to the neural network at a time of learning into a vector in a high dimensional space including high frequencies. A function 7 used for the conversion is expressed as follows.

γ(p)=(sin(2⁰πp), cos(2⁰πp), . . . , sin(2^{L-1}πp), cos(2^{L-1}πp)) Math. 3

As a parameter L in the above equation is increased, more detailed 3D scene information including a high-frequency component can be obtained. Utilizing this, the type-specific 3D scene information obtaining section 80 obtains a plurality of pieces of 3D scene information different from each other in the information density in parallel by setting a plurality of parameters L and performing the machine learning individually. However, means for controlling the information density of the 3D scene information is not limited to this. For example, in place of Positional Encoding, Multiresolution Hash Encoding may be applied which sets a grid of a plurality of resolutions and expresses an input vector on the basis of a positional relation to vertices of the grid (for example, see Thomas Muller and three others, “Instant Neural Graphics Primitives with a Multiresolution Hash Encoding,” ACM Transactions on Graphics, July 2022, Vol. 41, No. 4, Article 102, pp. 1-15).

In this case, the type-specific 3D scene information obtaining section 80 can obtain a plurality of pieces of 3D scene information different from each other in the information density in parallel by setting a plurality of level numbers L corresponding to the number of the grid resolutions and individually performing the machine learning. In these cases, a plurality of values to be set as the parameters L are prepared in advance in a memory within the type-specific 3D scene information obtaining section 80. Then, the type-specific 3D scene information obtaining section 80 obtains a plurality of pieces of 3D scene information different from each other in the information density in parallel by sequentially using the plurality of training images generated for one scene by the training image generating section 78, and stores the plurality of pieces of 3D scene information in the 3D scene information storage section 84 or updates the same types of 3D scene information that are already stored.

In this case, even in the same scene, a learning speed differs according to the information density. The lower the information density is, the more quickly the learning is completed, and therefore, the more quickly the 3D scene information is updated. Incidentally, in a case of setting the grid and performing the machine learning, the type-specific 3D scene information obtaining section 80 may set only one level number L and perform the learning, and individually select grids of different levels (for example, a grid of levels 0 to 1, a grid of levels 0 to 2, . . . , a grid of levels 0 to L−1, or the like) and read data at a time of transmission to the client terminal 10 or the like. Also in this case, the learning is similarly completed more quickly for a grid of lower levels, that is, a grid of lower information density, and, in turn, effects to be described later are similarly obtained.

The types of the 3D scene information obtained by the type-specific 3D scene information obtaining section 80 are not limited to distinctions in the information density. For example, the type-specific 3D scene information obtaining section 80 may obtain a plurality of pieces of 3D scene information different from each other in terms of a region as a learning target or an object in the display world. In this case, the smaller the range set as a learning target in the display world is, the more quickly the learning is completed, and therefore, the more quickly the 3D scene information is updated.

Thus, even in the same scene, the plurality of types of 3D scene information obtained by the type-specific 3D scene information obtaining section 80 can cause a difference in a time taken to complete the update, depending on the density of the information represented by the 3D scene information and the size of the range. The type-specific 3D scene information obtaining section 80 therefore records the time of the reflected scene in association with each of the plurality of types of 3D scene information stored in the 3D scene information storage section 84. Incidentally, the type-specific 3D scene information obtaining section 80 may obtain a plurality of types of 3D scene information different from each other in terms of a combination of the information density and the learning target range.

The 3D scene information transmitting section 86 transmits the data of the latest 3D scene information stored in the 3D scene information storage section 84 to the client terminal 10. The 3D scene information transmitting section 86 transmits the data of the 3D scene information to the client terminal 10 in order from 3D scene information obtained by completing the learning of one scene. For example, in a case where the data of 3D scene information having different information densities is set as a transmission target, the learning is completed in order from 3D scene information having a low information density, as described above. Hence, at a time point of completion of the learning of 3D scene information having a lowest information density, the 3D scene information transmitting section 86 transmits the data of the 3D scene information having the lowest information density, and at a time point of completion of the learning of 3D scene information having a next lowest information density, the 3D scene information transmitting section 86 transmits the data of the 3D scene information having the next lowest information density. The 3D scene information transmitting section 86 thus performs the transmission gradually up to 3D scene information having a highest information density.

The 3D scene information transmitting section 86 internally includes a dividing section 88. The dividing section 88 divides each of the plurality of types of 3D scene information representing one scene into a plurality of pieces of data. The 3D scene information representing one scene is constituted by individual neural networks for each type. The dividing section 88 divides each neural network into a plurality of neural networks. Here, the division means that some of nodes that are mutually different are removed while the structure of nodes associated with each other by a hash table or the like is maintained. The nodes to be removed in the neural networks after the division are determined randomly.

A method referred to as a dropout is known which randomly inactivates some of the nodes of a neural network in order to alleviate overfitting (see, for example, Nitish Srivastava and four others, “Dropout: A Simple Way to Prevent Neural Networks from Overfitting,” Journal of Machine Learning Research, June 2014, Vol. 15, pp. 1919-1958). As is clear from this dropout, the accuracy of a learning result is maintained at a certain level or higher even when some of the nodes of a neural network are inactivated.

Utilizing this characteristic, the client terminal 10 can generate a display image with a relatively high accuracy even when using 3D scene information in which some of nodes are removed. Accordingly, when the content server 20 transmits a plurality of neural networks representing the same 3D scene information after removing some of nodes, robustness against a packet loss can be enhanced while an increase in data size is suppressed. The image generating section 56 of the client terminal 10 can reconstruct the neural network before the division and render the display image when there is no packet loss. When there is a packet loss, the image generating section 56 renders the display image by using the neural network that can be obtained. As described above, the generation of the display image is possible also in this case.

In addition, as described above, the plurality of types of 3D scene information representing one scene may arrive from the content server 20 with a time difference. In this case, the image generating section 56 of the client terminal 10 updates the display image by using newly obtained 3D scene information. The resolution of the display image corresponds to the information density of the 3D scene information. Thus, the resolution of the display image is gradually increased by obtaining the 3D scene information in order from 3D scene information having a low information density. Here, the 3D scene information having the low information density reduces a sampling number in volume rendering, and therefore increases the rendering speed of the display image.

As a result, a time from a start of the learning of each scene to display thereof can be shortened significantly by first obtaining 3D scene information involving a short learning time and having a low information density in the content server 20, and rendering an image of a low resolution in a short time. In addition, it is ultimately possible to display a high-definition image by using 3D scene information having a high information density. Thus, display with a low delay can be realized while an effect on an appearance is suppressed. As described above, the types of the 3D scene information are not limited to distinctions in resolution. For example, the content server 20 may learn only a partial region gazed at by the user in a short time and transmit the partial region first, and thereafter transmit the 3D scene information of the whole of the scene. Also in this case, an image expression such that the region being gazed at is displayed with a low delay and an image of the periphery is updated afterward is made possible by similar principles.

Incidentally, the 3D scene information transmitting section 86 may transmit the 3D scene information representing one scene to the client terminal 10 by communication protocols different according to the types of the 3D scene information. For example, the 3D scene information transmitting section 86 may transmit the 3D scene information of a region in which the fineness of the image is to be given priority by transmission control protocol/internet protocol (TCP/IP) of high reliability, and transmit the 3D scene information of a region in which a low-delay characteristic of motion is to be given priority by user datagram protocol (UDP) of high transfer speed. Thus, a correspondence relation between the types of the 3D scene information and the communication protocols suitable for the types of the 3D scene information is set in an internal memory of the 3D scene information transmitting section 86 or the like in advance.

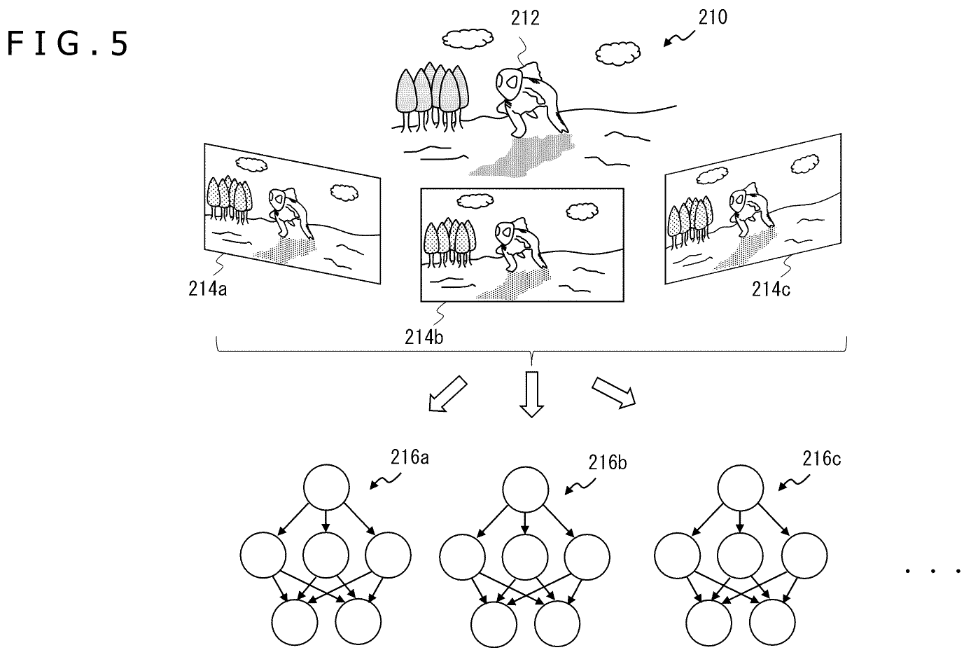

FIG. 5 schematically illustrates a procedure for the content server 20 to obtain 3D scene information. The display world control section 74 first constructs, for example, a display world 210 in which there is an enemy character 212. There may be motion in the display world 210, as described above. However, here, the display world 210 corresponding to one scene is illustrated. For this, the training viewpoint generating section 72 generates a plurality of training viewpoints on the basis of the latest display viewpoint or the like, and the training image generating section 78 generates training images 214a, 214b, and 214c or the like corresponding to the respective training viewpoints. Incidentally, the number of the generated training images is not limited to any specific number.

The type-specific 3D scene information obtaining section 80 performs machine learning by using the training images 214a, 214b, and 214c or the like, and updates a plurality of types of 3D scene information. The entities of the respective pieces of 3D scene information are neural networks 216a, 216b, 216c, . . . . The neural networks 216a, 216b, 216c, . . . are different from each other in at least either of the information density and a represented range. In a case where the information density is made different, the type-specific 3D scene information obtaining section 80 performs the learning by setting each of the parameters L described above, for example. In this case, the lower the information density of 3D scene information, the earlier the completion of the learning of the 3D scene information becomes.

In a case where the represented range is made different, the type-specific 3D scene information obtaining section 80, for example, cuts out corresponding regions from the training images 214a, 214b, and 214c, and performs the learning. In this case, the smaller the represented range of 3D scene information, the earlier the completion of the learning of the 3D scene information becomes. In a case of effecting the variation by combining the information density and the represented range, a time until the completion of the learning varies depending on a balance between the information density and the represented range. Qualitatively, the higher the information density, and the larger the represented range, the later the completion of the learning becomes. Thus, the balance between the information density and the size of the range is optimized in advance so as to obtain an appropriate delay time. When the illustrated processing is repeated at a predetermined rate, the neural networks 216a, 216b, 216c, . . . are each updated according to a change in the scene.

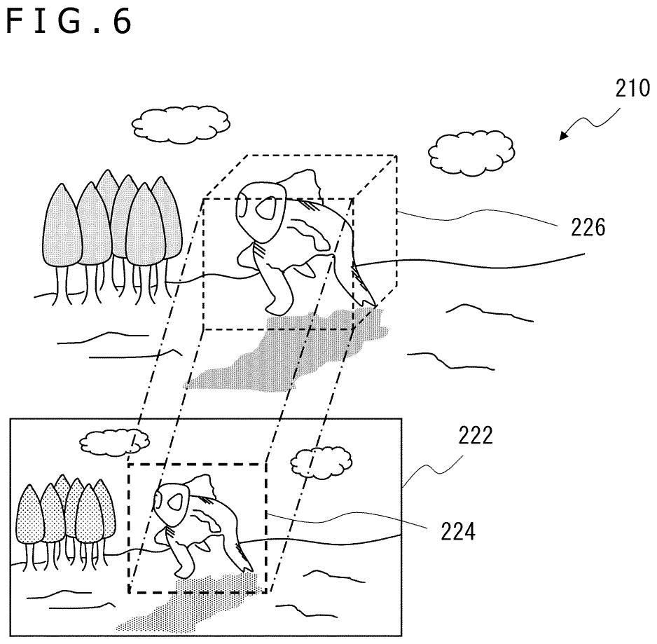

FIG. 6 is a diagram of assistance in explaining a mode of obtaining 3D scene information of a different range. Suppose that a part of the scene of the display world 210 illustrated in FIG. 5 is represented as a display image 222. The type-specific 3D scene information obtaining section 80 individually obtains, for example, 3D scene information representing a range 226 within the display world 210, the range 226 corresponding to an important region 224 on the display image 222, and 3D scene information representing the whole of the scene including the outside of the range 226. Here, the important region 224 is, for example, a region in a predetermined range from a gazing point of the user, a region in a predetermined range from the center of the display image, a region in which a war situation or an object obtained is represented, a region in which main objects such as the enemy character and the user character are present, or the like. A rule of selecting the region is set in advance according to the details of the content or the like.

Alternatively, the type-specific 3D scene information obtaining section 80 may directly specify a main object itself present in the display world 210 or a range in a predetermined size including the object, and obtain the 3D scene information as a learning target. In a case where the range to be learned is determined on the basis of the gazing point of the user, a well-known gazing point detector is provided to the client terminal 10. Then, the input information obtaining section 70 of the content server 20 obtains information regarding the gazing point from the client terminal 10 at a predetermined rate, and individually determines the range to be learned.

The type-specific 3D scene information obtaining section 80 may individually learn a range of the display world corresponding to the display image 222 being displayed on the client terminal 10 and a larger range including the outside of the range. In any case, the type-specific 3D scene information obtaining section 80 cuts out a partial corresponding region from the plurality of training images generated by the training viewpoint generating section 72 and performs the machine learning, and also performs the machine learning of the larger range by using the whole of the training images or the like.

It is to be noted that the number of variations of the range represented by the 3D scene information is not limited to two and may be three or more. In addition, there is no limitation on an inclusion relation between the ranges, and the 3D scene information may be obtained for each of a plurality of independent ranges. In any case, the 3D scene information is obtained by an amount corresponding to the number of set ranges. As the range is reduced, a learning time and a rendering time are shortened, and thus, display with a low delay is enabled. Utilizing this characteristic, even when the information density of the 3D scene information corresponding to the important region 224 is increased to a certain degree, as long as the range is small, rendering can be completed in a time equal to that taken to render an image of a large range by using 3D scene information of low information density. As a result, the important region 224 can be displayed with a high definition and a low delay.

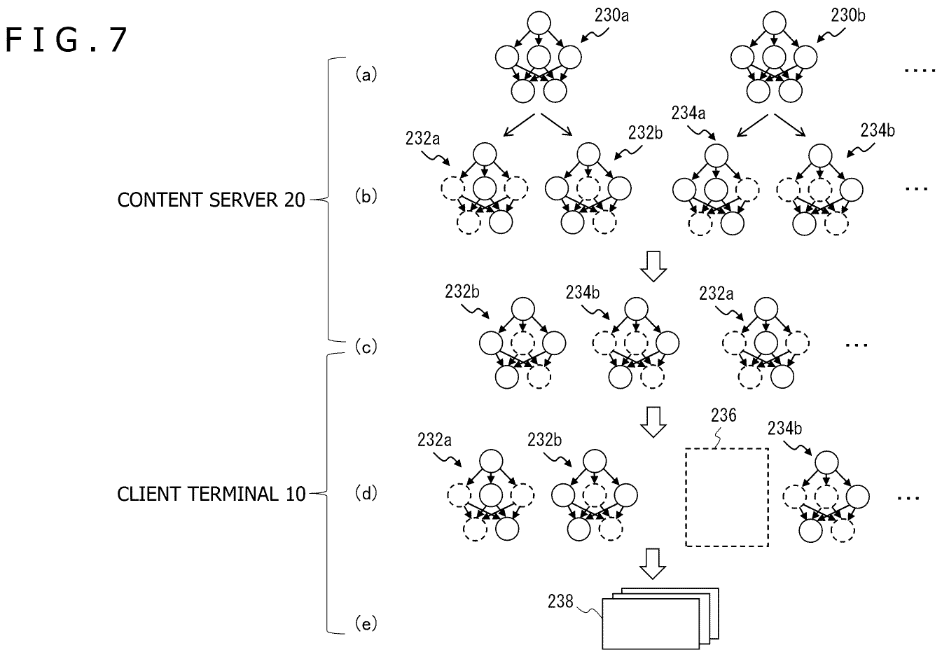

FIG. 7 schematically illustrates transitions of data in the transmission and reception of 3D scene information. The passage of time is represented from a top to a bottom of the figure. (a) to (c) represent state transitions of the data in the content server 20, and (c) to (e) represent state transitions of the data in the client terminal 10. In addition, this figure illustrates the 3D scene information representing one scene. First, as illustrated in (a), the type-specific 3D scene information obtaining section 80 of the content server 20 obtains a plurality of neural networks 230a, 230b, . . . , respectively corresponding to a plurality of types of 3D scene information on the basis of newly generated training images.

Next, as illustrated in (b), the 3D scene information transmitting section 86 of the content server 20 divides each of the neural networks 230a and 230b. That is, the 3D scene information transmitting section 86 generates a plurality of neural networks 232a and 232b, which are obtained by excluding some of nodes that are mutually different in the neural network 230a. In addition, the 3D scene information transmitting section 86 generates a plurality of neural networks 234a and 234b, which are obtained by excluding some of nodes that are mutually different in the neural network 230b.

In the figure, the nodes excluded from the original neural networks 230a and 230b in the neural networks 232a, 232b, 234a, and 234b after the division are indicated by dotted lines. When the nodes removed in one neural network 232a of the neural networks 232a and 232b after the division of a certain neural network 230a are left in the other neural network 232b, the original neural network 230a can be fully restored by combining the neural networks 232a and 232b with each other.

However, as described above, even when there occurs a missing node due to a packet loss or the like, an image can be generated on the basis of the remaining neural networks. Incidentally, the number of divided neural networks is not limited to two. The dividing section 88 of the 3D scene information transmitting section 86 preferably randomly determines the nodes to be excluded by a method similar to the dropout. The 3D scene information transmitting section 86 packetizes the neural networks 232a, 232b, 234a, and 234b after the division, and transmits the packetized neural networks 232a, 232b, 234a, and 234b to the client terminal 10.

At this time, as illustrated in (c), the 3D scene information transmitting section 86 randomly interchanges the order of transmission of packets of the plurality of neural networks. In the figure, transmission in order of the neural networks 232b, 234b, 232a, . . . is indicated by a horizontal sequence. Interchanging the transmission order can reduce a possibility of losing all of a certain types of 3D scene information due to consecutive packet losses. However, as for the targets of the interchange, the interchange is performed between neural networks updated in parallel within an allowable predetermined time. This prevents the interchange from delaying the rendering processing more than necessary.

When the 3D scene information obtaining section 52 of the client terminal 10 sequentially obtains the packets, the 3D scene information obtaining section 52 reconstructs the neural networks before the division by restoring the order of the neural networks that are extracted, as illustrated in (d). For this purpose, the content server 20 adds, in advance, to each of the neural networks 232b, 234b, 232a, . . . to be transmitted, metadata indicating which of the original neural networks 230a, 230b, . . . is divided into each of the neural networks 232b, 234b, 232a, . . . .

In the example of the figure, the 3D scene information obtaining section 52 can obtain the neural networks 232a and 232b, and can therefore fully reconstruct the original neural network 230a. On the other hand, as for the original neural network 230b, one neural network 234a of the neural networks formed by dividing the original neural network 230b cannot be obtained due to a packet loss, as indicated by a dotted line frame 236. In this case, the original neural network 230b cannot be fully reconstructed. In any case, the image generating section 56 of the client terminal 10 renders display images 238 as illustrated in (e) by using the neural networks 232a, 232b, and 234b that can be obtained.

Specifically, the image generating section 56 renders an image of the scene as viewed from the latest display viewpoint by volume rendering using the neural networks 232a, 232b, and 234b. In a case where the plurality of types of 3D scene information are transmitted with a time difference, the image generating section 56 updates at least some of the display images 238 by using latest 3D scene information. It is thereby possible to realize display such that the resolution of the image is increased gradually or an important image moves with a low delay in particular.

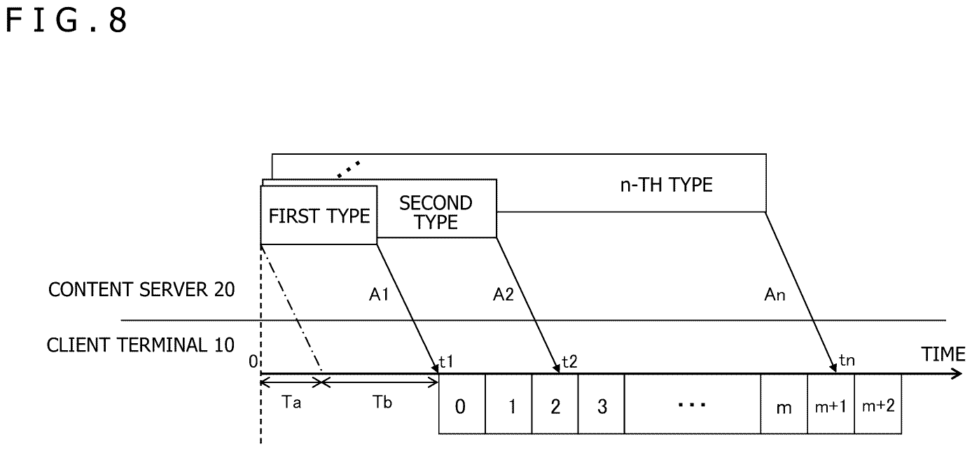

FIG. 8 is a diagram of assistance in explaining a temporal relation between machine learning in the content server 20 and image rendering in the client terminal 10. Here, as an example, a case is assumed in which a plurality of types of 3D scene information different from each other in the information density are transmitted. A horizontal direction of the figure is a time axis. Learning times in the content server 20 and the rendering times of respective frames of the display image in the client terminal 10 are each indicated by a rectangle. Numbers given to the rectangles of the respective rendering times indicate the order of the frames.

As illustrated on an upper side, the type-specific 3D scene information obtaining section 80 of the content server 20 individually learns 3D scene information of a first type, a second type, . . . , an n-th type. Here, the ordinal numbers correspond to levels of information density. Suppose that the first type represents a lowest information density, and that the n-th type represents a highest information density. As illustrated in the figure, even when the type-specific 3D scene information obtaining section 80 starts the learning of the plurality of types of 3D scene information at the same time, more time is taken to complete the learning as the information density is increased. At a time point of completion of the learning of the 3D scene information of the first type, the content server 20 first transmits the 3D scene information of the first type to the client terminal 10, as indicated by an arrow A1.

The client terminal 10 uses the 3D scene information of the first type to render images of frames of numbers 0, 1, and 2 at a lowest resolution from time t1. Meanwhile, at a time point of completion of the learning of the 3D scene information of the second type, the content server 20 transmits the 3D scene information of the second type to the client terminal 10, as indicated by an arrow A2. The client terminal 10 renders images at a resolution corresponding to the information density of the second type from a frame of number 3, for which the rendering is started immediately after time t2 at which the 3D scene information of the second type is obtained. The resolution of the frames is gradually increased by repeating similar processing.

When the content server 20 completes the learning of the 3D scene information of the n-th type, the content server 20 transmits the 3D scene information of the n-th type to the client terminal 10, as indicated by an arrow An. The client terminal 10 renders images at a highest resolution corresponding to the information density of the n-th type from a frame of number m+2, for which the rendering is started immediately after time tn at which the corresponding 3D scene information is obtained. Thus, in the present embodiment, the plurality of types of 3D scene information representing the same scene are learned, and 3D scene information whose learning is completed early is immediately transmitted to the client terminal 10. Consequently, as compared with a case of transmission of only 3D scene information of a high information density such as the n-th type, for example, a time of a start of the rendering of frames can be advanced significantly.

That is, when a time at which the learning is started in the content server 20 is set as a reference, rendering can be started with a delay of only a time Ta for the transmission of data and a time Tb taken to learn the 3D scene information of the first type. Incidentally, in actuality, before time t1, the rendering of frames by using the 3D scene information of a previous scene transmitted immediately previously may be performed. In addition, the image generating section 56 at a time of rendering each frame performs volume rendering on the basis of the latest display viewpoint obtained immediately previously. It is thereby possible to display the images of frame numbers 0 to m+2 in which not only is the resolution simply increased but also movement of the viewpoint is reflected with a low delay. Here, the lower the information density of the 3D scene information such as the first type, the smaller the sampling number in volume rendering, and the higher the rendering speed, thus enabling display with a smaller delay.

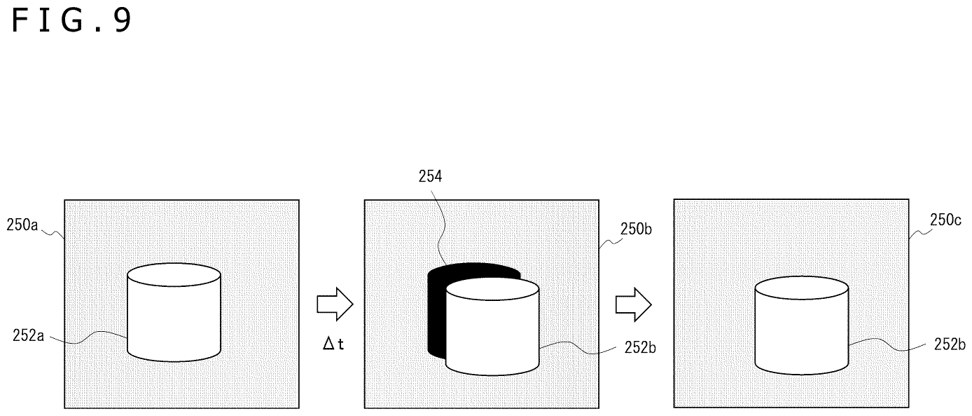

Thus, the image generating section 56 can be said to have a function of correcting a once generated image so as to match the latest display viewpoint irrespective of whether or not the image is already displayed. FIG. 9 is a diagram of assistance in explaining image correction processing by the image generating section 56 of the client terminal 10. An image 250a is a frame of a display image or a part thereof, and represents an image 252a of a cylindrical object as a foreground. The position of the cylindrical object relatively changes due to movement of the viewpoint. When an image 252b of the object is shifted in an image 250b after the passage of a time Δt, a need for rendering anew a background region 254 hidden in the image 250a arises.

With a conventional technology that displays an image transmitted from the content server 20 without using the 3D scene information, it is difficult to generate anew the region 254 not represented in the original image 250a. When the 3D scene information including information regarding the object and a region on the periphery thereof is used, all of pixels of the image 250b can be determined so as to correspond to the latest viewpoint, and therefore, naturally, the rendering of the region 254 is also made possible. In addition, when the display viewpoint moves and thereby a positional relation between the object and a light source changes, the color of the image 252b of the object can also change. The 3D scene information is used also for this, and the change in color can be expressed accurately by rendering an image as viewed from the new display viewpoint. It is thereby possible to generate an image 250c after the passage of a time Δt with high accuracy.

Incidentally, as described thus far, assuming that the client terminal 10 renders each frame of the display image by using the 3D scene information, the images 250a and 250c are each an image rendered by the client terminal 10 using the latest 3D scene information at the time point of the rendering. On the other hand, assuming a mode of transmitting the display image from the content server 20 together with the 3D scene information, it is possible for the client terminal 10 to correct the image 250a transmitted from the content server 20, by using the 3D scene information.

For example, the client terminal 10 generates the image 250c corrected in such a manner that the movement of the viewpoint that occurs during the period of the time difference Δt from the time point of the generation of the image 250a on the content server 20 side to the display of the image 250a on the client terminal 10 is reflected. Also in this case, the image generating section 56 of the client terminal 10 renders again, by using the latest 3D scene information, the region 254 not represented in the image 250a generated by the content server 20 and the image 252b whose color is changed.

In this case, the high-quality image 250a generated in the content server 20 and the region rendered anew in the client terminal 10 are synthesized. The image generating section 56 therefore preferably renders the necessary region by using the 3D scene information of high information density. Incidentally, in a situation in which a little feeling of strangeness is caused even when the image in the image 250a transmitted from the content server 20 is only moved or deformed, the image generating section 56 can omit new rendering processing using the 3D scene information. For example, for a far-located object involving a small amount of image shift or a small change in color with respect to a change in the display viewpoint, the image generating section 56 may make a correction by directly processing the image 250a, for example.

Therefore, the image generating section 56 stores, in an internal memory or the like in advance, a rule for determining a region that needs to be rendered again by using the 3D scene information. For example, when the speed of the display viewpoint exceeds a threshold value or is predicted to exceed the threshold value, the image generating section 56 may render an object whose distance from the viewpoint is equal to or less than the threshold value and a region on the periphery thereof again by using the 3D scene information. In this case, the content server 20 also transmits geometry information of the display world to the client terminal 10. The image generating section 56 can thereby obtain a change in the distance between the display viewpoint and the object.

According to the present embodiment described above, the content server 20 generates training images representing the display world of content, and obtains a plurality of types of 3D scene information of each scene. The content server 20 sequentially transmits 3D scene information whose learning is completed to the client terminal 10. The client terminal 10 renders a frame of the display image corresponding to the latest display viewpoint by using the 3D scene information. The learning time is changed by variously setting the density of information and the extent of the represented range as types of the 3D scene information, and, in turn, a delay time until display can also be controlled. Further, a level of detail can also be partially raised. It is therefore possible to display an image of high quality with a low delay with importance in the image or the like taken into consideration.

In addition, the content server 20 divides a neural network constituting one piece of 3D scene information into a plurality of neural networks and transmits the plurality of neural networks to the client terminal 10. It is thereby possible to enhance robustness against a packet loss while suppressing an increase in data size. From the above, in image processing involving distribution from the content server 20, an effect of the intervention of the distribution can be reduced, so that the quality of user experience can be enhanced.

The present disclosure has been described above on the basis of the embodiment thereof. The embodiment is illustrative, and it is to be understood by those skilled in the art that combinations of constituent elements and processing processes of the embodiment are susceptible of various modifications, and that such modifications also fall within the scope of the present disclosure.

As described above, the present disclosure is applicable to various types of information processing devices such as a content server, a game device, a head-mounted display, a display device, a portable terminal, and a personal computer, an image display system including one of these information processing devices, and the like.

The present disclosure may include the following aspects.

### Item 1

A content server including: a circuit (circuitry) configured to have the following configuration, in which the circuit (circuitry) generates, as training images, images representing states in which each scene of a three-dimensional display world whose conditions change according to a user operation is viewed from a plurality of viewpoints, obtains a plurality of types of 3D scene information representing three-dimensional information of each scene by machine learning using the training images as labeled data, and transmits data of the plurality of types of 3D scene information to a client terminal configured to render a display image by using the 3D scene information in order of completion of the machine learning of each scene.

### Item 2

The content server according to Item 1, in which the circuit (circuitry) obtains a plurality of pieces of the 3D scene information different from each other in spatial information density.

### Item 3

The content server according to Item 1, in which the circuit (circuitry) divides a neural network constituting one piece of the 3D scene information into a plurality of neural networks in which some of nodes that are mutually different are excluded, and then transmits the plurality of neural networks to the client terminal.

### Item 4

The content server according to Item 3, in which the circuit (circuitry) packetizes the neural networks after the division, and randomly interchanges order of the transmission of the neural networks.

### Item 5

The content server according to Item 1, in which the circuit (circuitry) obtains a plurality of pieces of the 3D scene information representing different ranges in the display world.

### Item 6

The content server according to Item 5, in which the circuit (circuitry) obtains 3D scene information representing a range of the display world, the range corresponding to a region determined in an image being displayed on the client terminal.

### Item 7

The content server according to Item 5, in which the circuit (circuitry) obtains 3D scene information targeted for an object present in the display world.

### Item 8

The content server according to Item 1, in which the circuit (circuitry) transmits the data of the plurality of types of 3D scene information to the client terminal by different communication protocols.

### Item 9

A client terminal including: a circuit (circuitry) configured to have the following configuration, in which the circuit (circuitry) obtains information regarding a user operation and information regarding a display viewpoint with respect to a three-dimensional display world, obtains, from a server, data of a plurality of types of 3D scene information representing three-dimensional information, the 3D scene information being obtained by machine learning, for each scene of the display world whose conditions change according to the user operation, and renders at least a part of a frame of a display image by using the 3D scene information obtained immediately previously, on the basis of the display viewpoint that is latest.

### Item 10

The client terminal according to Item 9, in which the circuit (circuitry) obtains a plurality of neural networks in which some of nodes that are mutually different are excluded, the plurality of neural networks being formed by dividing a neural network constituting one piece of the 3D scene information, and reconstructs the neural network before being divided.

### Item 11

The client terminal according to Item 9, in which the circuit (circuitry) obtains a plurality of pieces of the 3D scene information different from each other in spatial information density in increasing order of the information density, and changes a resolution of the frame in such a manner that the resolution of the frame corresponds to the information density of the obtained 3D scene information.

### Item 12

The client terminal according to Item 9, in which the circuit (circuitry) renders, by using the 3D scene information, a region whose rendering is determined to be necessary due to a change in the display viewpoint in a display image transmitted from the server.

### Item 13

An image display system including: a client terminal configured to display an image of a three-dimensional display world whose conditions change according to a user operation; and a content server configured to transmit data to be used for generation of a display image, the client terminal and the content server including a circuit (circuitry) configured to have the following configuration, in which the circuit (circuitry) included in the content server generates, as training images, images representing states in which each scene of the display world is viewed from a plurality of viewpoints, obtains a plurality of types of 3D scene information representing three-dimensional information of each scene by machine learning using the training images as labeled data, and transmits data of the plurality of types of 3D scene information to the client terminal in order of completion of the machine learning of each scene, and the circuit (circuitry) included in the client terminal obtains information regarding the user operation and information regarding a display viewpoint with respect to the display world, obtains the data of the plurality of types of 3D scene information from the content server, and renders at least a part of a frame of a display image by using the 3D scene information obtained immediately previously, on the basis of the display viewpoint that is latest.

### Item 14

A display data transmitting method including: generating, as training images, images representing states in which each scene of a three-dimensional display world whose conditions change according to a user operation is viewed from a plurality of viewpoints; obtaining a plurality of types of 3D scene information representing three-dimensional information of each scene by machine learning using the training images as labeled data; and transmitting data of the plurality of types of 3D scene information to a client terminal configured to render a display image by using the 3D scene information in order of completion of the machine learning of each scene.

### Item 15

A display image generating method including: obtaining information regarding a user operation and information regarding a display viewpoint with respect to a three-dimensional display world; obtaining, from a server, data of a plurality of types of 3D scene information representing three-dimensional information, the 3D scene information being obtained by machine learning, for each scene of the display world whose conditions change according to the user operation; and rendering at least a part of a frame of a display image by using the 3D scene information obtained immediately previously, on the basis of the display viewpoint that is latest.

### Item 16

A recording medium recording a program for making a computer implement: a function of generating, as training images, images representing states in which each scene of a three-dimensional display world whose conditions change according to a user operation is viewed from a plurality of viewpoints; a function of obtaining a plurality of types of 3D scene information representing three-dimensional information of each scene by machine learning using the training images as labeled data; and a function of transmitting data of the plurality of types of 3D scene information to a client terminal configured to render a display image by using the 3D scene information in order of completion of the machine learning of each scene.

### Item 17

A recording medium recording a program for making a computer implement: a function of obtaining information regarding a user operation and information regarding a display viewpoint with respect to a three-dimensional display world; a function of obtaining, from a server, data of a plurality of types of 3D scene information representing three-dimensional information, the 3D scene information being obtained by machine learning, for each scene of the display world whose conditions change according to the user operation; and a function of rendering at least a part of a frame of a display image by using the 3D scene information obtained immediately previously, on the basis of the display viewpoint that is latest.

What is claimed is:

1. A content server comprising:
one or more processors; and
a memory device storing instructions that, when executed by the one or more processors, cause the content server to:
generate, as training images, images representing each scene of a three-dimensional display world viewed from a plurality of viewpoints, wherein a state of the three-dimensional display world is configured to change according to an operation;
obtain a plurality of types of three-dimensional scene information representing three-dimensional information of each scene by machine learning using the training images as labeled data; and
transmit data of the plurality of types of three-dimensional scene information to a client terminal in an order of completion of the machine learning of each scene.

2. The content server according to claim 1, wherein the instructions cause the content server to obtain a plurality of pieces of the three-dimensional scene information different from each other in spatial information density.

3. The content server according to claim 1, wherein the instructions cause the content server to:
divide a neural network comprising a piece of the three-dimensional scene information into a plurality of neural networks by excluding at least two mutually different nodes; and
transmit the plurality of neural networks to the client terminal.

4. The content server according to claim 3, wherein the instructions cause the content server to:
packetize the plurality of neural networks into a plurality of packets; and
randomize an order of transmission of the plurality of packets.

5. The content server according to claim 1, wherein the instructions cause the content server to obtain a plurality of pieces of the three-dimensional scene information representing a plurality of different scopes in the display world.

6. The content server according to claim 5, wherein the instructions cause the content server to obtain three-dimensional scene information representing a portion of the display world, the portion corresponding to a region determined in an image being displayed on the client terminal.

7. The content server according to claim 6, wherein the region determined in the image is selected based on user gaze-tracking information received from a gaze detection sensor of the client terminal.

8. The content server according to claim 5, wherein the instructions cause the content server to obtain three-dimensional scene information targeted for an object present in the display world.

9. The content server according to claim 1, wherein the instructions cause the content server to transmit the data of the plurality of types of three-dimensional scene information to the client terminal using a plurality of communication protocols.

10. The content server according to claim 9, wherein the plurality of communication protocols include Transmission Control Protocol (TCP) used to transmit a first type of the three-dimensional scene information optimizing image resolution, and User Datagram Protocol (UDP) used to transmit a second type of the three-dimensional scene information optimizing low latency.

11. The content server according to claim 1, wherein the instructions cause the content server to generate the plurality of viewpoints within a spherical volume of a predetermined radius centered on a latest display viewpoint of the client terminal, the predetermined radius being determined based on a maximum expected velocity of the display viewpoint.

12. A client terminal comprising:
one or more processors; and
a memory device storing instructions that, when executed by the one or more processors, cause the client terminal to:
obtain information regarding an operation on the client terminal and information regarding a display viewpoint with respect to a three-dimensional display world;
obtain, from a server, data comprising a plurality of types of three-dimensional scene information representing three-dimensional information for each scene of the three-dimensional display world, wherein a state of the three-dimensional display world is configured to change according to the operation; and
render at least a portion of a frame of a display image based on the latest display viewpoint using the most recent three-dimensional scene information.

13. The client terminal according to claim 12, wherein the instructions cause the client terminal to:
obtain a plurality of first neural networks, the plurality of first neural networks being generated by dividing a second neural network comprising a piece of the three-dimensional scene information into the plurality of first neural networks while excluding at least two mutually different nodes; and
reconstruct a second neural network comprising a piece of the three-dimensional scene information from the plurality of first neural network,
wherein the plurality of first neural networks has been generated by dividing the second neural network into the plurality of first neural networks while excluding at least two mutually different nodes.

14. The client terminal according to claim 12, wherein the instructions cause the client terminal to:
obtain a plurality of pieces of the three-dimensional scene information different from each other in spatial information density in an increasing order of the information density; and
change a resolution of the frame, wherein the resolution of the frame corresponds to the information density of the obtained three-dimensional scene information.

15. The client terminal according to claim 12, wherein the instructions cause the client terminal to render a region due to a change in the display viewpoint in the display image using the three-dimensional scene information.

16. An image display system comprising:
a client terminal configured to display an image of a three-dimensional display world, wherein a state of the three-dimensional world is configured to change according to an operation on the client terminal; and
a content server configured to transmit data regarding a display image,
wherein the content server is configured to:
generate, as training images, images representing each scene of the three-dimensional display world viewed from a plurality of viewpoints;
obtain a plurality of types of three-dimensional scene information representing three-dimensional information of each scene by machine learning using the training images as labeled data; and
transmit data including the plurality of types of three-dimensional scene information to the client terminal in an order of completion of the machine learning of each scene, and
wherein the client terminal is configured to:
obtain information regarding the operation and information regarding a display viewpoint with respect to the three-dimensional display world;
obtain the data from the content server, the data comprising the plurality of types of three-dimensional scene information; and
render at least a portion of a frame of a display image based on the latest display viewpoint using the most recent three-dimensional scene information.

17. A display data transmitting method comprising:
generating, as training images, images representing each scene of a three-dimensional display world viewed from a plurality of viewpoints, wherein a state of the three-dimensional display world is configured to change according to an operation;
obtaining a plurality of types of three-dimensional scene information representing three-dimensional information of each scene by machine learning using the training images as labeled data; and
transmitting data of the plurality of types of three-dimensional scene information to a client terminal in an order of completion of the machine learning of each scene.

18. A display image generating method comprising:
obtaining information regarding an operation and information regarding a display viewpoint with respect to a three-dimensional display world;
obtaining, from a server, data of a plurality of types of three-dimensional scene information representing three-dimensional information for each scene of the three-dimensional display world, wherein a state of the three-dimensional display world is configured to change according to the operation; and
rendering at least a portion of a frame of a display image based on the latest display viewpoint using the most recent three-dimensional scene information.

19. A non-transitory computer-readable medium storing a computer program that, when executed by one or more processors, causes the one or more processors to perform operations comprising:
generating, as training images, images representing each scene of a three-dimensional display world viewed from a plurality of viewpoints, wherein a state of the three-dimensional display world is configured to change according to an operation;
obtaining a plurality of types of three-dimensional scene information representing three-dimensional information of each scene by machine learning using the training images as labeled data; and
transmitting data of the plurality of types of three-dimensional scene information to a client terminal in an order of completion of the machine learning of each scene.

20. A non-transitory computer-readable medium storing a computer program that, when executed by one or more processors, causes the one or more processors to perform operations comprising:
obtaining information regarding an operation and information regarding a display viewpoint with respect to a three-dimensional display world;
obtaining, from a server, data of a plurality of types of three-dimensional scene information representing three-dimensional information for each scene of the three-dimensional display world, wherein a state of the three-dimensional display world is configured to change according to the operation; and
rendering at least a portion of a frame of a display image based on the latest display viewpoint using the most recent three-dimensional scene information.
